(19) United States
(12) Patent Application Publication
(10) Pub. No.: US 2012/0109913 A1
(43) Pub. Date: May 3, 2012

(54) METHOD AND SYSTEM FOR CACHING REGULAR EXPRESSION RESULTS

(76) Inventors: Abhay C. Rajure, Fremont, CA (US); Saurabh Shrivastava, Sunnyvale, CA (US)

(21) Appl. No.: 13/051,125

(22) Filed: Mar. 18, 2011

Related U.S. Application Data
(60) Provisional application No. 61/408,632, filed on Oct. 31, 2010.

(51) Int. Cl. G06F 17/30

(52) U.S. Cl. 707/694; 707/E17.005

(57) ABSTRACT

A method and system for efficiently processing regular expressions associated with new BGP packets uses the caches results of prior processing of regular expressions associated with a prior matching BGP packet within the same epoch.

### CROSS REFERENCE TO RELATED APPLICATION

This application claims the benefit of U.S. Patent Application Ser. No. 61/408,632, filed on Oct. 31, 2010, entitled METHOD AND SYSTEM FOR CACHING REGULAR EXPRESSION RESULTS FOR BGP PROCESSING, which application is incorporated herein by reference in its entirety.

### FIELD OF THE INVENTION

The invention relates generally to communication networks and, more specifically but not exclusively, to processing complex regular expressions.

### BACKGROUND

BGP (Border Gateway Protocol) is a protocol for exchanging routing information between routers such as those associated with gateway hosts in a network such as the Internet. Updated routing information, in the form of an updated routing table or portion thereof, is communicated to the various hosts when one host detects a change.

BGP uses Communities and AS-Paths, match criteria for which are primarily defined by complex regular expressions. Each complex regular expression received at, illustratively, a BGP router or other network element must be evaluated as part of an import/export policy processing operation. Evaluation the complex regular expressions in each BGP update and applying the corresponding policy rules takes a time such that a relatively slow convergence (updating) of local routing tables may occur.

### SUMMARY

Various deficiencies in the prior art are addressed by embodiments for efficiently processing regular expressions associated with new BGP packets using cached results of prior processing of regular expressions associated with a prior matching BGP packet within the same epoch.

One embodiment is adapted for use in use in a network element including a memory and processing packets according to actions defined by a plurality of rules provided as regular expressions, wherein in response to a received packet having attributes matching attributes of a previously processed packet within a current epoch, processing the packet according to the actions used to process the previously processed packet; and in response to the packet having attributes not matching attributes of a previously processed packet within the current epoch, comparing the packet to each of the plurality of regular expressions to determine which rules match the packet, processing the packet according to the actions defined by the rules matching the packets, and storing in a cache an attribute object associated with the packet and with the rules matching the packet.

### BRIEF DESCRIPTION OF THE DRAWINGS

The teachings herein can be readily understood by considering the following detailed description in conjunction with the accompanying drawings, in which:

FIG. 1 depicts a high-level block diagram of a system including an exemplary router and control mechanism benefiting from an embodiment;

FIG. 2 depicts a graphical representation of a method for building and distributing a regular expression map according to an embodiment;

FIG. 3 depicts a flow diagram of a method for building a regular expression map according to an embodiment;

FIG. 4 depicts a flow diagram of a method for assigning epoch identifiers and regular expression identifiers according to an embodiment;

FIG. 5 depicts a flow diagram of a method according an embodiment;

FIG. 6 depicts a flow diagram of a method for validating cache data according to an embodiment;

FIG. 7 depicts a high-level block diagram of a computing device suitable for use in implementing various functions described herein;

FIG. 8 graphically depicts exemplary Ri-attribute and Ro-attribute AVL trees; and

FIG. 9 depicts a flow diagram of a method for processing management data according to one embodiment.

To facilitate understanding, identical reference numerals have been used, where possible, to designate identical elements that are common to the figures.

### DETAILED DESCRIPTION OF THE INVENTION

Within the context of a router or other switching device, policies specifying router configuration, packet routing, packet filtering and other parameters define such parameters using regular expressions that must be evaluated to specify routes in a routing table, to configure packet filters, to configure route filters, to configure policers and so on. Within the context of a Border Gateway Protocol (BGP) router, regular expressions are useful in defining AS-path access lists and community lists to enable simplified filtering of routes.

Generally speaking, policy rules are defined by regular expressions, which provide a compact nomenclature for describing a pattern, such as metacharacters to define a pattern to match against an input string. This nomenclature is standardized. Within the context of routing or switching equipment, the patterns may represent packet processing instruction such as packet routing instructions, packet filtering instructions and the like. For example, specifying a routing operation wherein incoming packets having a characteristic matching a particular pattern are to be routed in a particular manner (e.g., route packets having a destination address beginning with “345” to a particular interface card). Generally speaking, if a regular expression can match two different parts of an input string, it will match the earliest part first.

A static policy provides a set of rules against which each incoming and/or outgoing packet in a router or other switching device is tested. These rules are provided during initial policy configuration and modified during subsequent policy updates. Each rule is defined using a regular expression and is used to test each packet entering a network element (input rules) and/or leaving a network element (output rules). These regular expressions are updated during network policy updates.

An epoch is associated with a finite number of identifiers (e.g., a range of IDs), where each rule has a unique ID, and each newly received or modified rule is assigned a respective next unique ID. Each packet is processed against all of the rules to define the appropriate action to be taken (dropped, forwarded, etc.), unless the packet is the same as a previously processed packet within the same epoch. In this case, the action taken for the packet is the same as that taken for the previously processed packet. In this manner, the processing of incoming and/or outgoing packets is optimized by avoiding at least some of the processing of packets against the rules defined by the various policies. A packet to be processed is deemed to be the same as a previously processed packet where a set of attributes associated with the packet to be processed matches a set of attributes associated with the previously processed packet. A regular expression processing system and method within the context of, illustratively, a Border Gateway Protocol (BGP) router is depicted and described herein. However, it should be noted that the teachings, methods, systems, techniques and so on described herein may also be applied to other protocols, routers, switching devices, network elements and the like (i.e., any device benefiting from improved regular expression evaluations).

Various disclosed embodiments enable efficient and scalable processing of regular expressions such that BGP convergence time is improved. For example, various embodiments use caching to avoid repeated processing of regular expressions associated with the same type of traffic (e.g., AS-PATH and COMMs), by building an adaptive cache of RegEx matches and using one or more mechanisms to integrate and use this cache to implement policies in a BGP engine.

One embodiment creates a distributed cache of match results for as-path entries and a central cache for community entries. All of these caches navigate through the match entries of various regular expressions using a parent RegEx map. Various combinations of distributed and central caches are used in different embodiments.

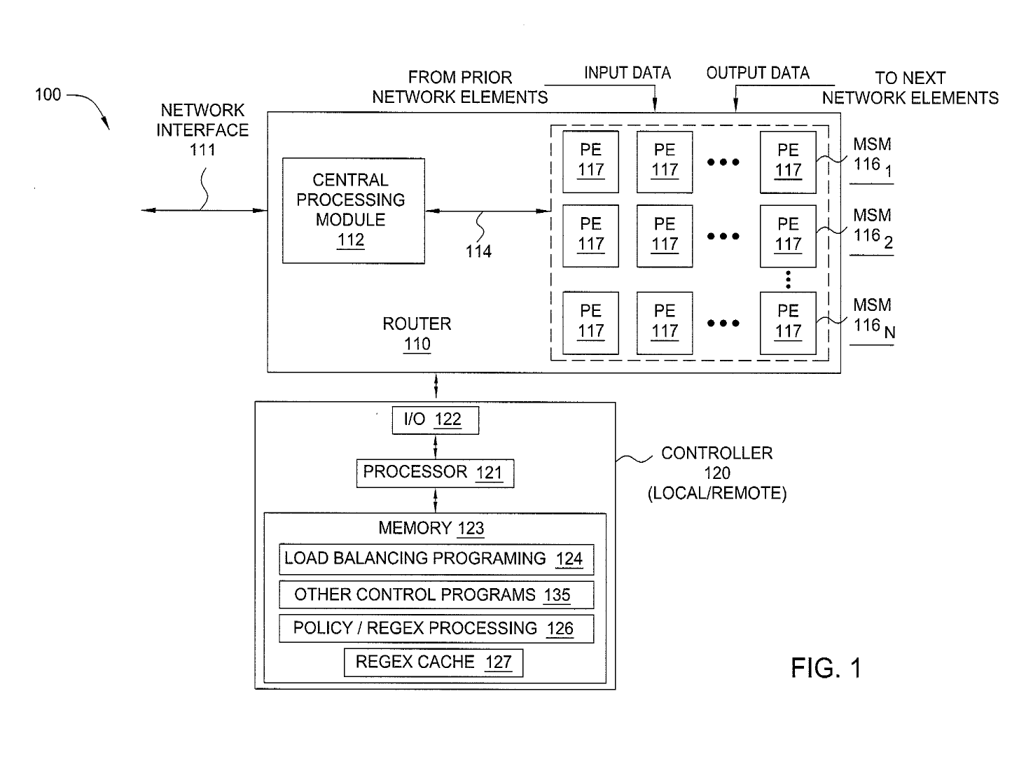

FIG. 1 depicts a high-level block diagram of a system including an exemplary router and control mechanism according to one embodiment. As depicted in FIG. 1, system 100 includes an exemplary router 110 and a controller 120.

The exemplary router 110 may support one or more of a PGW function, an SGW function, and other functions within a wired or wireless network environment. For purposes of this discussion is assumed that the exemplary router 110 is representative of one or more of a plurality of PGW, SGW or other routing/switching elements within a communication system including a plurality of routing/switching elements of various types.

The exemplary router 110 includes a network interface 111 via which the exemplary router may communicate with other devices, which may include peer and non-peer devices. Although depicted as having a single network interface 111, it will be appreciated that exemplary router 110 may include any suitable number of network interfaces.

The exemplary router 110 includes a central processing module (CPM) 112 in communication with each of a plurality of mobile service modules (MSMs) 116₁-116_{N} (collectively, MSMs 116), where each MSM 116 includes a respective plurality of processing elements or processing entities (PEs) 117. Generally speaking, the router 110 receives input traffic data from various input ports (not shown) from one or more prior network elements. The router 110 utilizes a switch fabric to route the input traffic data toward various output ports (not shown) for transmission toward next network elements

Each of the MSMs 116 cooperates with input ports, output ports and so on (not shown) to provide some or all of the elements associated with the switch fabric of router 110. While the general routing of packets within a switch fabric of a router will not be discussed in detail with respect to the present embodiments, it will be appreciated that modifications to the switch fabric configuration within the context of the various embodiments may be made consistent with policy changes such as provided via the processing of regular expressions. Although depicted and described with respect to an embodiment in which each MSM 116 includes a plurality of PEs 117, in other embodiments one or more of the MSMs 116 may include only one PE 117.

Generally speaking, the exemplary router 110 is configured for supporting communication between CPM 112 and MSMs 116 via control channel 114 to adapt the operation of the switch fabric and/or the elements associated with the switch fabric. In general, the load associated with routing packets of traffic flows through exemplary router 110 is distributed across the PEs 117 of MSMs 116, under control of management software that is controlling CPM 112.

As depicted in FIG. 1, exemplary router 110 is controlled by a controller 120. The controller 120 may be implemented in any manner suitable for enabling controller 120 to control exemplary router 110.

In one embodiment, the controller 120 may be a module integrated with exemplary router 110. In one such embodiment, for example, the controller 120 may be implemented as a portion of CPM 112 and/or CPM 112 may be implemented as a portion of controller 120.

In one embodiment, as depicted in FIG. 1, controller 120 may be a device external to exemplary router 110, which may be directly connected to the exemplary router 110 (e.g., via direct physical connection) or indirectly connected to the exemplary router 110 (e.g., via a network communication path). In one such embodiment, for example, controller 120 is a local or remote management system.

In one embodiment, for example, controller 120 includes a processor 121, input-output (I/O) circuitry 122, and a memory 123, where processor 121 is configured for communicating with I/O circuitry 122 and memory 123. The I/O circuitry 122 may be configured to support communication between the controller 120 and exemplary router 110. The memory 123 may store various programs and data configured for use by processor 121 in supporting routing of traffic in accordance with various loading, policy and/or other concerns.

In one embodiment, for example, memory 123 stores a load balancing program 124, other control programs 125, a policy/regular expression processing program 126, a regular expression cache 127 and/or any other program(s), caches or databases suitable for controlling the operations of router 110.

One or more of the load balancing program 124, other control programs 125, the policy/regular expression processing program 126 or regular expression cache 127 may be executed by controller 120 to control the operation of CPM 112 to perform respective load balancing and/or policy related configuration/update operations. Similarly, one or more of the load-balancing program 124, other control programs 125, policy/regular expression processing program 126 or regular expression cache 127 may be downloaded from controller 120 to exemplary router 110 for use by CPM 112 to perform the respective load balancing, other control function processing, policy related configuration/update operations and/or regular expression caching operations.

It will be appreciated that control of exemplary router 110 by controller 120 may be implemented in any other suitable manner. In one embodiment, exemplary router 110 is an Alcatel-Lucent 7750 service router, although, as described herein, the policy/regular expression processing functionality described herein may be implemented within the context of any suitable type of router or other device processing regular expressions such as within the context of policy updates.

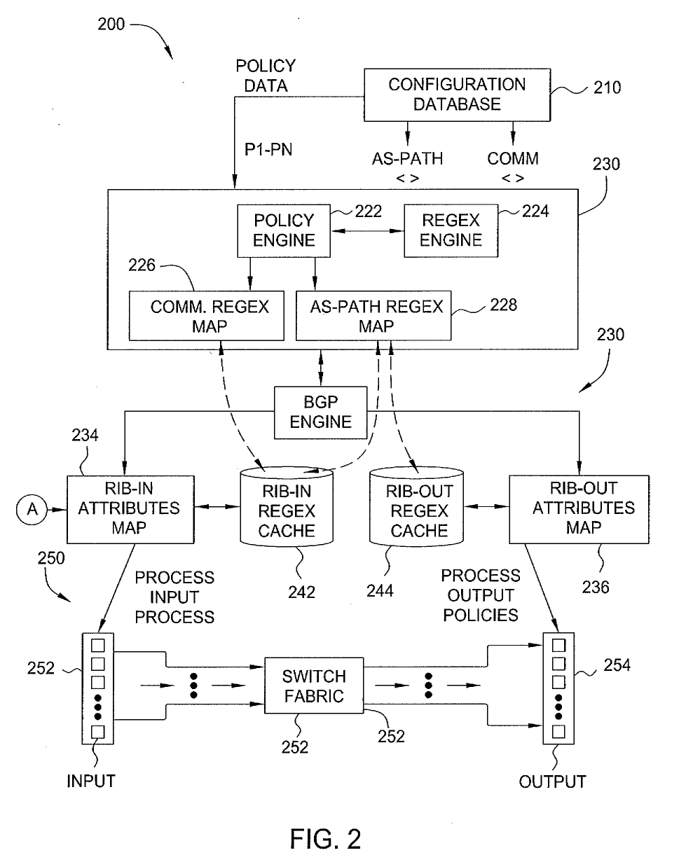

FIG. 2 depicts a graphical representation of a method for building and distributing a regular expression map. The graphical representation 200 of FIG. 2 is primarily a functional representation of various elements useful in understanding the present embodiments. The various functional elements depicted herein with respect to FIG. 2 may be combined with other functional elements as will be apparent to those skilled in the art and informed by the teachings of the present invention. Moreover, various functional elements depicted herein with respect to FIG. 2 may also be divided and/or distributed among other functional elements within the context of, illustratively, a router or router control mechanism such as described above with respect to FIG. 1 and/or the various other figures.

FIG. 2 generally depicts a configuration database 210, a regular expression processing module 220, a BGP processing module 230, regular expression caches 240 and exemplary configurable router elements 250.

The configuration database 210 provides policy data P1-PN defining, via complex regular expressions, various configuration/update information pertaining to BGP Communities (COMM) and AS-Paths (AS-PATH). As previously noted, initial or updated policies provide sets of rules against which each incoming and/or outgoing packet in a router or other switching device is tested. These rules are provided during initial policy configuration and modified during subsequent policy updates. Each rule is defined using a regular expression and is used to test each packet entering a network element (input rules) and/or leaving a network element (output rules). A policy update or new policy data provides for a change to one or more of the rules.

An epoch is associated with a finite number of identifiers (e.g., a range of IDs), where each rule has a unique ID, and each newly received or modified rule is assigned a respective next unique ID. Each packet is processed against all of the rules to define the appropriate action or actions to be taken (dropped, forwarded, etc.), unless the packet is the same as a previously processed packet within the same epoch. In this case, the action taken for the packet is the same as that taken for the previously processed packet. In this manner, the processing of incoming and/or outgoing packets is optimized by avoiding at least some of the processing of packets against the rules defined by the various policies. The regular expression processing module 220 processes the policy data P1-PN to extract therefrom the rules providing updated policy data. The regular expression processing module 220 is depicted as including a policy engine 222 cooperating with a regular expression processing engine 224, a community regular expression map 226 and an AS-path regular expression map 228.

The policy engine 222 and regular expression engine 224 operate to process incoming policy data to extract therefrom the various rules defining configuration/update information pertaining to BGP Communities (COMM) and AS-Paths (AS-PATH), which information is stored in, respectively, community regular expression map 226 and an AS-path regular expression map 228.

The BGP processing module 230 is depicted as including a BGP engine 232, a RIB-IN attributes map 234 and a RIB-OUT attributes map 236. The RIB-IN attributes map 234 is used to store unique attribute sets associated with received network packets, The RIB-OUT attributes map 236 is used to store unique attribute sets associated with network packets to be transmitted.

Briefly, each network packet is processed against each of the appropriate input or output rules or regular expressions to determine whether the network packet included a pattern or characteristic that matched or did not match a particular rule. The result of this processing of the rules is cached, such as via a sequence of bits corresponding to a sequence of rules to be processed. Specifically, assuming up to 512 rules (e.g., an epoch with 512 unique IDs) are processed for a first packet, the results of that processing may comprise, illustratively, a corresponding 512 bit word where each bit is set to a logic level indicative of whether or not the packet matched thy corresponding rule (i.e., true/false, pass/fail, etc.). This 512 bit word is cached so that a subsequent packet that is the same as the first packet can simply be processed according to the cached 512-bit word resulting from the processing of the first packet against the (up to) 512 rules. Various modifications are contemplated by the inventors. For example, more or fewer rules may be used, more or fewer bits may be used for a cached word or other structure representing rule match results, more than one word may be used to cache the rule match results, and so on.

Generally speaking, the regular expressions provide a static set of rules applied to millions of packets entering and/or exiting a router or other switching element. A network update is a change to the specific rules or regular expressions to be applied to those packets.

The rules or regular expressions are not themselves cached. Rather, attribute sets or “nodes” associated with packets previously processed according to the rules are cached. The rules are simply defined in policy updates that may add new rules, delete existing rules or modify existing rules. One a policy is finalized (committed), the policy compiler defines a unique number or ID for each rule.

For each regular expression, the corresponding pattern is applied to network traffic/packets to decide what action to take with respect to a matching incoming network packet (e.g., forward the packet, drop the packet etc.). The specific action to be taken with respect to a first network packet (based on its matching of various rules) is also be taken with respect to any subsequent packets that are similar enough or substantially matching the first packet.

The Rib-in attributes map 234 stores unique attribute sets associated with received network packets, such as the first network packet. The set of attributes of each subsequently received network packet is compared to the previously stored attributes sets to determine if an attribute set match exits.

If the attribute set of a received network packet is substantially similar to a stored attribute set, then the received network packet is considered to be the same as the network packet associated with the stored attribute set. The received packet is then processed in the same manner as the network packet associated with the stored attribute set without processing the received packet against the set of regular expressions or rules.

If the attribute set of a received network packet is not the same as any of the stored attribute sets, then the attribute set of the received packet is stored in the Rib-in data structure and the received network packet is processed against the set of regular expressions or rules.

In one embodiment, the attribute set is defined using a portion a network packet, such as a header or portion of a header associated with the packet. In another embodiment, the attribute set is defined using a circular redundancy check (CRC) calculated using a portion of a network packet. The portions used can be those that describe AS-paths, Communities and the like.

The Rib-out data structure operates on output packets in substantially the same manner as described above with respect to the Rib-in data structure, which operates on input packets.

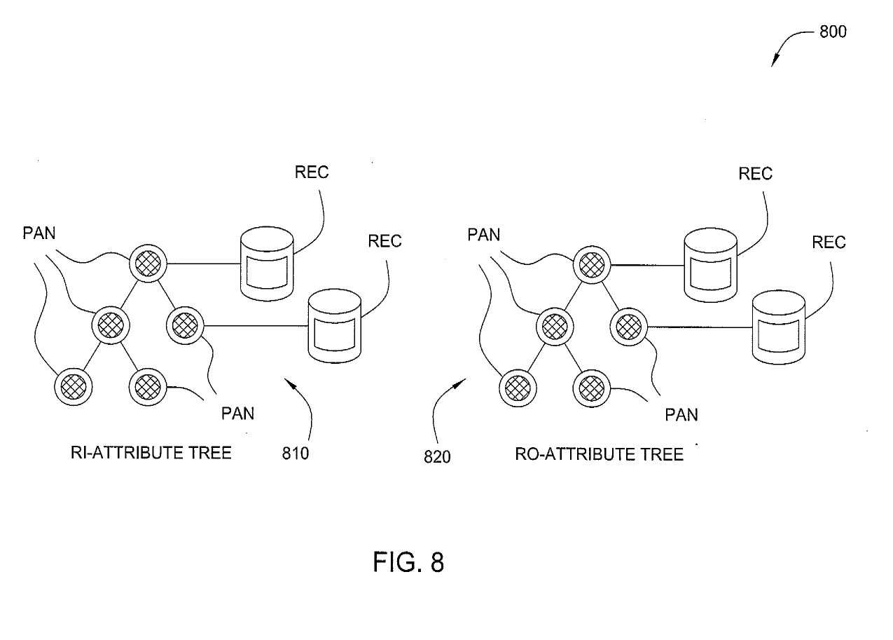

The attribute sets described herein with respect to the Rib-in and Rib-out data structures are, in various embodiments, represented as nodes in a hierarchical data structure such as described with respect to FIG. 8.

Regular expression caches 240, specifically RIB-IN cache 242 and a RIB-OUT cache 244 are used to store attribute sets or nodes associated with previously processed packets. Specifically, these caches are used to store the attributes of packets processed by the BGP processing module 230 within a predefined period of time or epoch, it will be appreciated by those skilled in the art that the caches 240 may be included within the regular expression processing module 220, BGP processing module 230 or some other location.

The caches 240 are accessible to regular expression processing elements such that the processing of identical packets using the regular expressions received within a predefined time period or epoch as discussed herein. That is, during a predefined period of time or epoch, if the regular expression processing module 220 receives for processing a new regular expression matching a previously processed regular expression (i.e., a regular expression associated with policy related information stored within a cache 240), the cached policy related information of the previously processed regular expression is used for the new regular expression such that complex processing associated with the new regular expression is avoided.

Policy Interaction

In various embodiments, the policy engine 222 and regular expression engine 224 operate to build a parent RegEx map from a received policy after policy commit. Once the RegEx map is built, child instances of distributed cache refer to this map. This map is updated upon any modification in the policy and reflected in the child caches accordingly. Each regular expression is associated with a corresponding RegEx object in the map.

Generally speaking, a policy defines a list of AS-Path and COMMUNITY entries containing regular expressions. Each RegEx represents a specific routing, filtering or other action to be taken for one or more received packets. For every AS-Path related RegEx entry in a policy, a corresponding RegEx object is created. Each instance of a RegEx is assigned a unique “epoch” entry and a unique “RegEx ID”.

RegEx ID: In order to build a bit map of the RegExs, each RegEx entry is assigned a unique 32-bit ID (more or fewer of bits may be used in various embodiments). This RegEx ID is generated at the policy compile time by the policy compiler. A finite ID space is reserved for a range of sequential (or non-sequential) RegEx ID's, and each RegEx is given a unique number or RegEx ID for identifying that instance of the RegEx in the policy.

Each new RegEx object is given a next available RegEx ID. If an existing RegEx entry is modified, then a new instance of that RegEx is created, the current RegEx ID is discarded and the next available RegEx ID is assigned to the modified RegEx entry. The discarded RegEx ID is not reused in the same epoch.

Epoch ID: A given range of RegEx IDs is associated with a particular epoch entry. Each epoch entry identifies a particular RegEx entry by a unique number in the given range. The policy compiler or other processing module keeps track of the assigning of numbers within an epoch.

The transition to a next epoch occurs when the given range of RegEx IDs for the current epoch is exhausted, which may occur after one policy commit or multiple policy commits. When this occurs, the policy compiler assigns a new epoch number for a group of ID's.

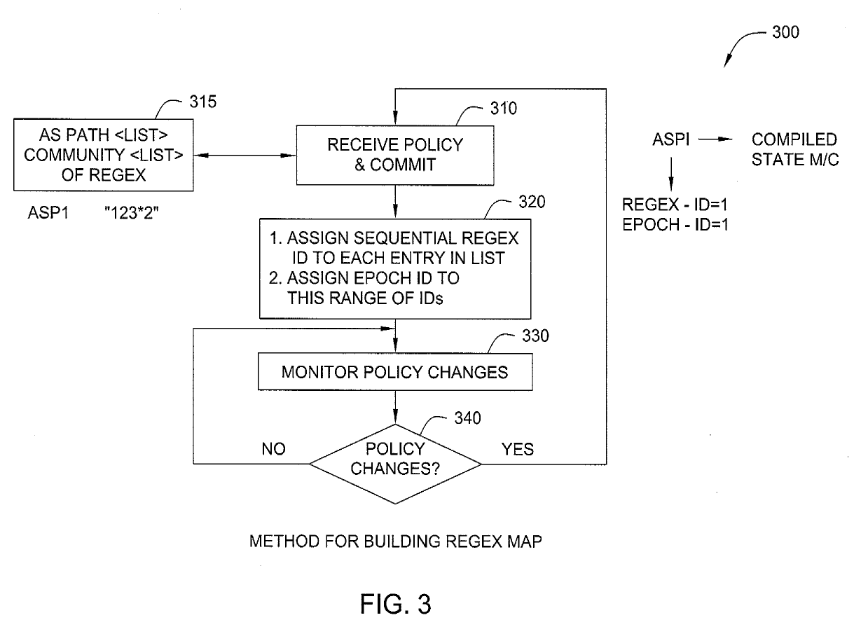

FIG. 3 depicts a flow diagram of a method for building a regular expression map. The method 300 of FIG. 3 will be discussed primarily within the context of processing operations conforming to the functions described above with respect to FIG. 2. However, it will be appreciated that the method of FIG. 3 may be implemented using various other configurations and/or processing mechanisms described herein. The method 300 may be invoked by, illustratively, the policy compiler 222.

At step 310, policy data along with a respective commitment is received by, illustratively, the regular expression processing module 220. Referring to box 315, regular expressions defining Communities and AS-Paths list policies are provided via, illustratively, configuration database 210.

At step 320, a sequential regular expression identifier (RID) is assigned to each entry in the list. Moreover, an epoch ID (EID) is assigned to the range of RIDs in the list. The size of the epoch or the range of RIDs associated with an epoch may be predetermined or modified based on various criteria, such as available cache memory space, available processing resources, the presence or absence of specific regular expressions exists and so on.

At step 330, the method 300 monitors the policy to determine if any changes have occurred. If a policy change has occurred, then the method 300 is directed at step 342 repeat steps 310 and 320.

Generally speaking, the policy engine 222 within the regular expression processing module 220 cooperates with the RegEx engine 224 to process policy data provided by, illustratively, configuration database 210. The processing regular expressions within the policy data yields RegEx objects which are stored in the communities RegEx map 226 or AS-path RegEx map 228 as appropriate.

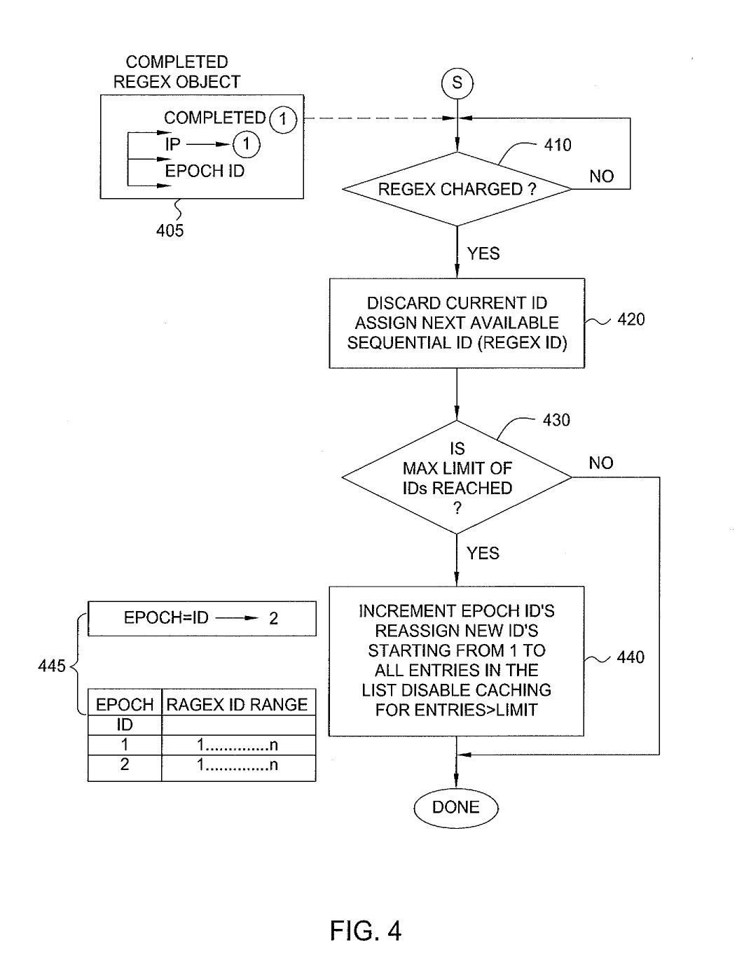

FIG. 4 depicts a flow diagram of a method for assigning epoch identifiers and regular expression identifiers according to one embodiment. The method 400 may be implemented for instantiated within, illustratively, the regular expression processing module 220.

At step 410, a determination is made as to whether a regular expression has changed. That is, referring to box 405, a compiled regular expression object including state information, a regular expression identifier and an epoch identifier is examined to determine whether a relevant change has occurred. That is, a determination is made as to whether a new regular expression is currently being processed by, illustratively, the regular expression processing module 220.

If the determination at step 410 indicates that a change has occurred with respect to a particular regular expression (e.g., a new regular expression is being processed), then at step 420 the current ID is discarded and a next available sequential regular expression ID is assigned to the regular expression being processed.

At step 430, a determination is made as to whether the maximum number or limit of regular expression identifiers has been reached, such as the maximum number of identifiers associated with a particular epoch. If not, then the method 400 exits.

If the determination at step 430 indicates that a maximum number of regular expression identifiers has been reached, then at step 440 the epoch ID is incremented, new regular expression IDs are assigned to all entries in the list (beginning at an initial value), and caching is disabled for entries exceeding this limit. Referring to box 445, an epoch ID is illustrated as being increased from 1 to 2, while a data structure depicting epoch IDs 1 and 2, as well as their respective groups of regular expression IDs is also illustrated.

The method 300 and 400 depicted above with respect to FIGS. 3 and 4 build a map of regular expressions associated by epoch IDs and regular expression IDs such that any new regular expression received for processing may be compared to the previously processed regular expressions to determine if actions associated with a previously processed regular expression may be used for the newly received regular expression.

Building Distributed Cache(s) for AS-Path Matches

In one embodiment, a BGP engine stores all incoming and outgoing BGP route updates/path attributes in AVL-trees. Specifically, an Ri-attribute tree with unique path attributes entries is formed in response to received Ri-attribute data, and an Ro-attribute tree with unique path attributes entries is formed in response to received Ri-attribute data.

These path attributes entries are maintained such that routes in Rib-in with the same path attributes share a single instance of that Rib-in path attribute. Similarly there is a Ro-attributes tree with unique path attributes entries. These path attributes entries are maintained such that routes in Rib-out with the same path attributes share a single instance of that Ro-attribute.

In various embodiments, the cache or caches described herein are built upon access such that there is no upfront cost associated with a cached attribute. This advantageously reduces the memory footprint associated with the cache, since not all attributes will need regular expressions evaluated (e.g., they may be excluded by other simpler match criteria (source address, destination address, family of addresses and the like).

For various embodiments of the cache-based matching described herein, each path-attribute object is augmented to contain the “RegEx-match cache” to cache the results of ASPATH regular expression matches.

FIG. 8 graphically depicts exemplary Ri-attribute and Ro-attribute AVL trees. Specifically, an Ri-attribute tree 810 comprises a hierarchical arrangement of a plurality of path attribute nodes (PANs), where, illustratively, two of the path attribute nodes are associated with respective RegEx caches (RECs). Similarly, an Ro-attribute tree 820 comprises a hierarchical arrangement of a plurality of path attribute nodes (PANs), where, illustratively, two of the path attribute nodes are associated with respective RegEx caches (RECs). Various modifications to the structure are contemplated by the inventors. For example, more or fewer RECs may be used in either of the attribute trees. More or fewer PANs may be associated with respective or common RECs. In addition, while the Ri-attribute tree 810 and Ro-attribute tree 820 are depicted as having a similar hierarchical structure, it is noted that the hierarchical structure of these AVL trees may be different.

AS-Path Cache Entries

in one embodiment, each unique instance of path attribute object in the RI-attribute tree and RO-attribute trees will have an AS-Path match cache.

In one embodiment, the AS-Path cache contains an epoch ID and two bitmaps. The first bitmap contains the RegEx entries that have been applied to this attribute during policy import or export. The second bitmap contains the match results of the RegEx run applied for that RegEx entry in the first bitmap.

A path attribute entry may be part of multiple imported or exported routes. Thus each path attribute may match one or more RegEx patterns. As an example, a policy with four AS-Path entries may take the following form:

ASP1 “.*” → ID 1

ASP2 “1234” → ID2

ASP3 “.*800.*” → ID3

ASP4 “.*200.*500” → ID4

Path attribute: AS-SEQ {100, 200, 400, 500} → PA1

In this embodiment, if a policy contained 1, 3 & 4 AS-PATH entries in any from/to part of the policy for any peer(s) that share PA1, its cache entry may take the following form:

Epoch-id = <0-max>
RegEx ID range = <0, Max-epoch-limit>

| | | | | | | | |
|---|---|---|---|---|---|---|---|
| RegEx ID | 1 | 2 | 3 | 4 | — | — | Max- |
| Map: | | | | | | | epoch- |
| | | | | | | | limit |

AS-Path Cache

| | | | | |
|---|---|---|---|---|
| RegEx Map | 1 | 0 | 1 | 1 |
| Match Map | 1 | x | 0 | 1 |

Checking for Validity of AS-Cache Entries

A cache entry is valid only for the same epoch entry. For example, if the above AS-Path cache entry for ASP3 is modified, then its existing RegEx ID will be released and the next RegEx ID is generated, as follows:

ASP3 “.*800 700.*” → discard ID 3, generate new ID 5.

The discarded RegEx ID of 3 is never re-used within the same epoch. The cache entry for RegEx ID 3 may be deleted or simply ignored, since it will never accessed again.

When a new epoch entry is generated due to exhaustion of the RegEx ID space, then all of the existing RegEx cache entries become invalid since a new RegEx ID map must be created.

To maintain the validity of a cache, each AS-cache lookup procedure preferably includes an initial epoch entry check to determine if the present epoch entry is the same as the epoch entry associated with desired AS-Path cache entry. If different epochs are indicated, then the cache is invalid and must be clear (i.e., a new cash instantiated).

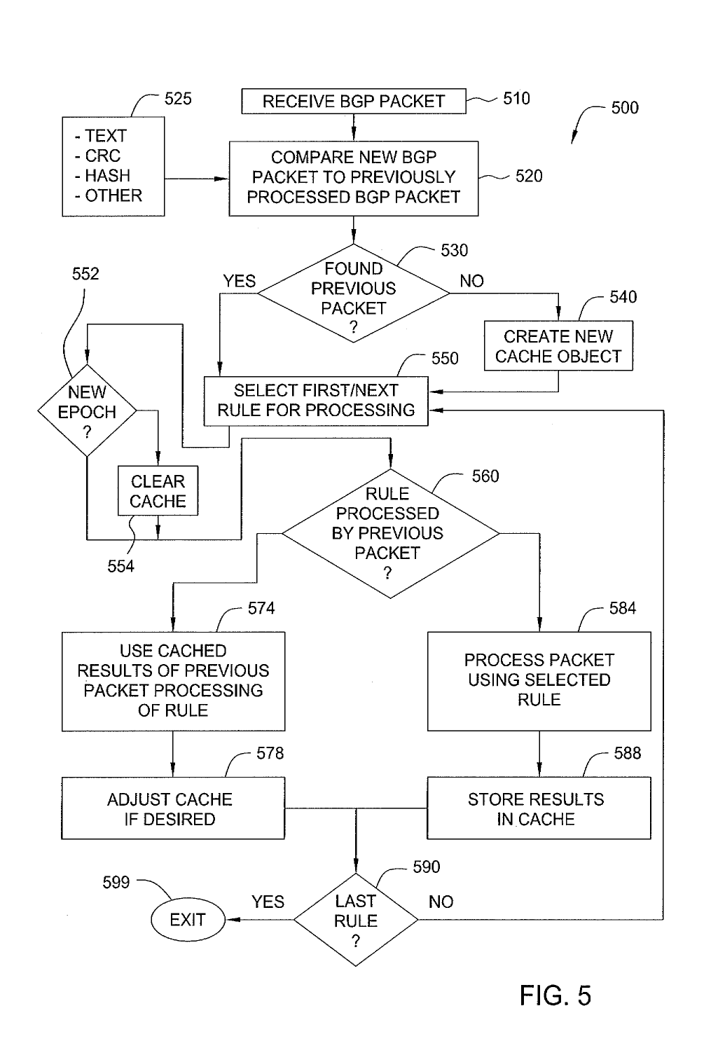

FIG. 5 depicts a flow diagram of a method for processing newly received BGP packets according to various embodiments discussed herein. Specifically, each received BGP packet is compared to a previously processed BGP packet to determine if a match exists. In the event of the match, the RegEx processing associated with the newly received BGP packet is avoided by processing the newly received BGP packet in the same manner as the previously processed BGP packet. That is, rather than processing the newly received BGP packet according to the regular expressions stored in the regular expression maps 226 and or 228, the results of the previously processed BGP packet are retrieved from the cache 242 and/or 244 and used for the newly received BGP packet.

It is noted that while the method 500 of FIG. 5 will be primarily described with respect to packet received an input port, it is also noted that packets to be transmitted by an output port may also be processed in a similar manner using the corresponding rib-out attributes map 236 and rib-out RegEx cache 244.

At step 510, a BGP packet is received by, illustratively, an input port 252.

At step 520, the newly received BGP packet is compared to previously processed BGP packets to determine if it is substantially the same as a previously processed BGP packet. The comparison may be performed using attributes associated with the newly received and previously processed BGP packet. These attributes are stored within the rib-in attributes map 234. Referring to box 525, a text comparison may be used, a circular redundancy check (CRC) comparison may be used, a hash table may be used and or other comparison/matching techniques may be used.

At step 530, a determination is made as to whether a match of the newly received BGP packet and a previously processed BGP packet has occurred per step 520. If no match has occurred, then a new cache object is created at step 540.

At step 550, a first or next rule within a list of rules to be processed for the received BGP packet is selected.

At step 552, a determination is made as to whether a new epoch has begun. If a new epoch has begun, then at step 554 the appropriate rib-in RegEx cache 242 or rib-out RegEx cache 244 is cleared. That is, a determination is made as to whether the epoch associated with the a cached object of the previously processed packet is the same as the epoch of the selected rule to be processed. If the rule was not processed during the present epoch then the rule must be processed again. Otherwise the results of the previous processing of the rule may be used, as described herein.

At step 560, a determination is made as to whether the selected rule was processed with respect to a matching, previously processed BGP packet.

If the selected rule was processed with respect to a matching, previously processed BGP packet, then at step 574 the newly received BGP packet is processed using the cached result of the previous processing of the selected rule for the previously processed packet. Optionally, at step 578 the cache is adjusted if desired.

If the selected rule was not processed with respect to a matching, previously processed BGP packet (or there is no matching a previously processed BGP packet), then at step 584 the newly received packet is processed according to the selected rule and its step 588 the results are stored in the cache.

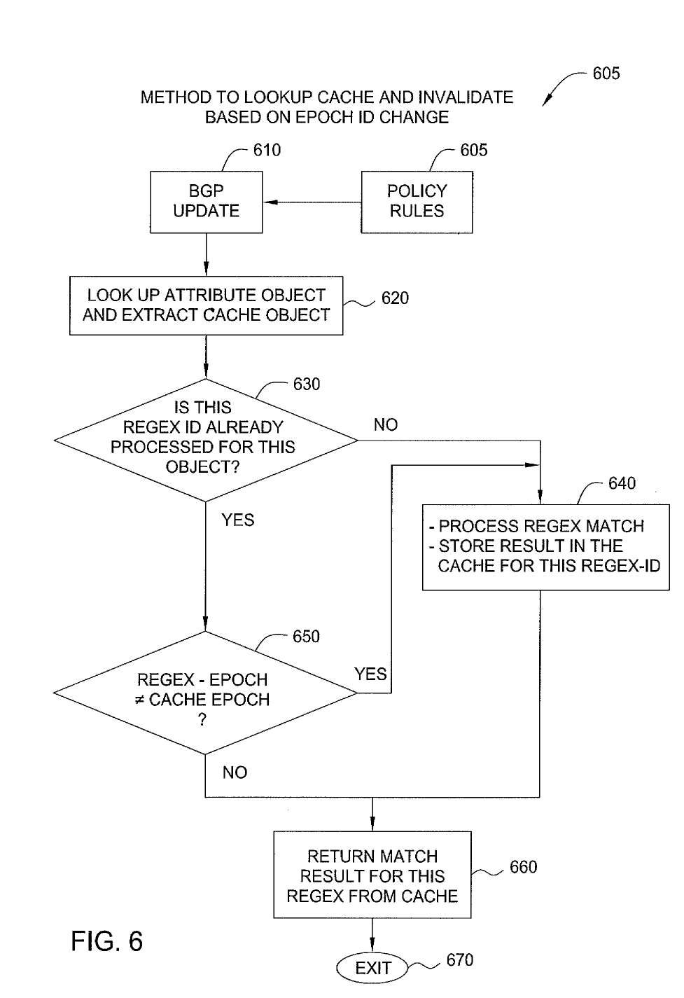

At step 590 a determination is made as to whether the presently selected rule is the last rules to be processed with respect to the newly received BGP packet. If additional rules are to be processed, the method 500 proceeds to step 550 to select the next rule for processing, and steps 560-590 are repeated. Otherwise, the method exits at step 599. RegExRegEx FIG. 6 depicts a flow diagram of a method for validating cache data based upon a change in epoch ID. That is, FIG. 6 depicts a method suitable for clearing caches in the event of a regular expression processing resulting in an exhaustion of regular expression IDs in a particular applicant such that a change in epoch ID is needed.

At step 610, BGP parameters are updated in response to policy rules, such as indicated with respect to box 605.

At step 620, a cache lookup operation is performed with respect to the attribute object and the relevant cached object is extracted from the cache.

At step 630, a determination is made as to whether the regular expression ID for this object has already been processed. If the regular expression ID for the subject has been processed already, then the method 600 proceeds to step 650. Otherwise, the method 600 proceeds to step 640.

At step 640, the regular expression is processed as depicted above with respect to the various figures and the results are cached along with the appropriate regular expression ID. The method then proceeds to step 660.

At step 650, a determination is made as to whether the epoch associated with the processed regular expression is the same as the epoch associated with the cache object. If the two epochs are different, then the method 600 proceeds to step 640 where the regular expression is processed as depicted above with respect to the various figures. That is, since the two epochs are different, the caches are to be cleared or flushed. Therefore, processing of regular expressions must begin anew since the previously generated pointers or indices mapping newly received regular expressions into the caches using the regular expression IDs will be invalid.

At step 660, the match result from the cache for the processed regular expression is returned to the calling routine, such as one or more of the methods described above. At step 670, the method 600 is exited.

Building a Central Communities Cache

The discussion herein with respect to FIGS. 1-6 as well as the discussion regarding the building and using AS-caches and related structures are generally applicable to the building and using of communities caches and related structures.

Since community entries in BGP update need to undergo some processing (e.g., identifying correct type: Normal, Extended), and the objects to match our extracted from the community entries, community-cache object are created. In one embodiment, these community-cache objects are kept in a community cache that is maintained per BGP instance. By maintaining a community cache on a per BGP instance basis, there is no need for a centralized or distributed database structure such as used above with respect to caching AS-path attributes. In this embodiment, each instance of community-cache object contains the RegEx-match cache, similar to the path attributes cache. Optionally, community-cached objects may be kept in a community cache that spans multiple BGP instances.

Cache Implementation

in one embodiment, the community cache is implemented as hash-table and the corresponding list. Entries in the list are sorted by the usage time. The Comm-cache is built as a hash of community IDs and associated cache objects. In this embodiment, the most recently used entry bubbles up to the top of the list, while the least recently used entry is at the bottom of the list. If during insertion of new entry, the Comm-cache is full, then the last or least recently used entry in the list is removed from the list. Anytime an existing entry is looked up in the cache, it is inserted at the top of the list, this creates a time-sorted list of entries.

Communities Cache Entries

In one embodiment, each Comm-cache entry contains similar bitmap as described above with respect to the AS-Path cache; namely, a processed RegEx and match map.

As previously noted, Import/Export policies are applied normally in BGP's rib-in and rib-out processing. While processing RegExs, the RegEx engine 224 first checks the cache for match-results. If no match results are present, then the RegEx engine 224 performs a full RegEx processing and stores the result in the appropriate cache.

Checking for Validity of Comm-Cache Entries

As previously noted with respect to AS-caches, when a change in epoch entry is detected with respect to a matched RegEx object and its corresponding Comm-cache entry, the entire local Comm-cache for the Comm-cache entry is reset or initialized. In this manner, a forced reevaluation of the associated RegExs and cache is provided such that the Comm-cache (and AS-cache(s)) will be repopulated. The new epoch entry from the RegEx object is then copied to this cache entry.

Adaptive AS-Cache(s) and Comm-Cache

Since any AS-Cache(s) or Comm-cache is limited in size and will lose its advantage if it has too many entries, various embodiments adapt cache usage by applying a selection criteria to RegEx objects prior to their caching. In particular, in one embodiment the RegEx engine 224 decides which RegEx objects are the best candidates for caching in one or both of the AS-Cache(s) or Comm-caches. This decision may be made at compile time or at some other time.

For example, some regular expressions may be processed so quickly that it is simply not worth caching corresponding RegEx objects.

In one embodiment, regular expressions adhering to predefined criteria are always fully processed without caching their corresponding RegEx objects and without regard to RegEx objects that may already be cached.

In one embodiment, empirical and/or statistical data is gathered with respect to the processing of various types of regular expressions (e.g., by inspecting the Finite Automation). This data is used to decide whether to cache certain As-path or Community RegEx entries.

In various embodiments, the RegEx engine 224 may choose certain entries for caching at run time; adapting to the behavior of RegEx engine & incoming data at run time. Since the time it takes to match regular expressions varies based on the input data that is applied to the process, at runtime the RegEx engine may flag certain matches to be cached even though initially they were not being cached, thus avoiding consequent costly processing.

Lockless Design

In one embodiment, to avoid a locking condition during cache access, each BGP instance is provided with a locally cached version of the RegEx-map and community's cache. In this embodiment, the RegEx engine 224 further operates to update caches of the appropriate BGP instance. Optionally, the AS-cache and Comm-cache are also localized per BGP instance.

For example, within the context of a plurality of BGP Virtual Private

Network (VPN) routing/forwarding (VRF) instances, each instance optionally has associated with it localized or cached version of the AS-cache and Comm-cache of a BGP core instance. The localized or cached versions are updated by the RegEx engine 224. In this manner, the likelihood of occurrence of database locking conditions associated with multiple instantiated entities trying to simultaneously access data in the main or core BGP instance AS-cache(s) and Comm-cache may be reduced.

Processing RegEx in a Non-BGP Context

When processing in non-BGP context such as RTM updates, a common cache is built for all such processing. While executing in the context of shell & CLI, the caching will be turned off.

Management and Reporting

in various embodiments, the collected information from the various caches supports management and reporting functions which identify those AS-Paths & Communities that are used heavily and, by extension, correlate such heavy usage with corresponding policy entries. In this manner, useful statistical information about the pattern of updates in the network is captured for subsequent use as a diagnostic tool to profile policy usage and the network's route update data.

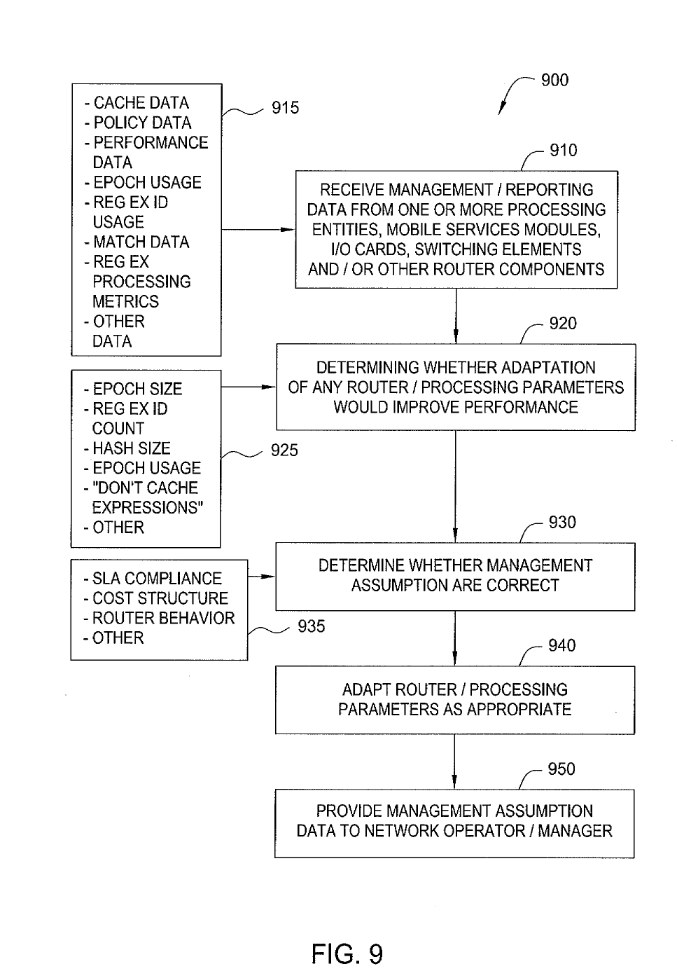

FIG. 9 depicts a flow diagram of a method for processing management data according to one embodiment. Specifically, the method 900 of FIG. 9 may be implemented using, illustratively, the central processing module 112 or controller 120 (local or remote) described above with respect to FIG. 1. Generally speaking, the method 900 of FIG. 9 may also be implemented by any computer or other processing entity in communication with a network element configured according to the teachings of the various embodiments, such as an element management system (EMS) or network management system (NMS). For example, a remote embodiment of the controller 120 such as discussed above with respect to FIG. 1 may comprise a computer or other processing entity associated with one or more EMS, NMS or other network control/management systems. Such network control/management systems may be operated by a service provider, network operator or other entity.

At step 910, the processing entity executing the method 900 receives management/reporting data from one or more processing entities, mobile service modules, I/O cards, switching elements and/or other components within a routing or switching device. Referring to box 915, such management/reporting data may comprise cache data, policy data, performance data, epoch usage data, RegEx ID usage data, match occurrence/frequency data, RegEx processing metrics and/or other data pertaining to the operation of the routing or switching device.

At step 920, a determination is made as to whether adaptation of any of the router/processing parameters associated with the routing or switching device would improve performance. Referring to box 925, parameters that may be adapted may include epoch size, RegEx ID count, hash table size, hash parameters, specific “do not cache” regular expressions and/or other parameters.

At optional step 930, a determination is made as to whether particular management assumptions are correct in view of the receives management/reporting data. Referring to box 935, management assumptions to be investigated may include service level agreement (SLA) compliance assumptions, cost and/or other structural assumptions, router behavior and/or other network element performance assumptions as well as other assumptions.

At step 940, router/processing parameters associated with the routing or switching device are adapted in accordance with the determination made at step 920. That is, configuration data and/or policy data is propagated to the routing or switching device to adapt various operating parameters such that improved performance of the device may be realized.

And optional step 950, results of the management assumptions determination made it optional step 930 are propagated to the network operator/manager for further processing.

Computer Implemented Embodiments

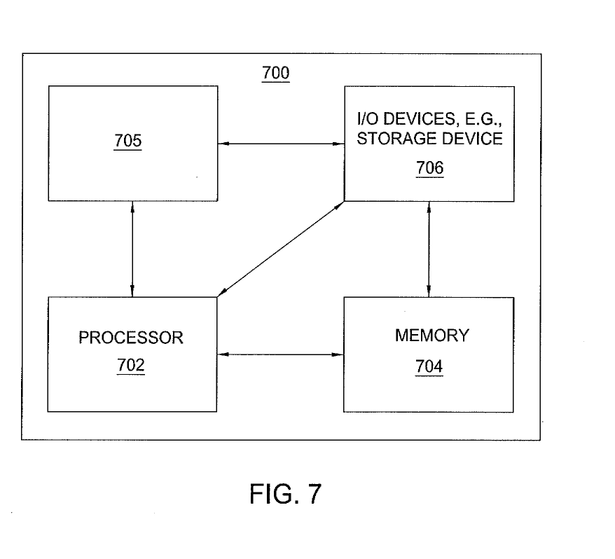

FIG. 7 depicts a high-level block diagram of a computer suitable for use in performing functions described herein.

As depicted in FIG. 7, computer 700 includes a processor element 702 (e.g., a central processing unit (CPU) and/or other suitable processor(s)), a memory 704 (e.g., random access memory (RAM), read only memory (ROM), and the like), a cooperating module/process 705, and various input/output devices 706 (e.g., a user input device (such as a keyboard, a keypad, a mouse, and the like), a user output device (such as a display, a speaker, and the like), an input port, an output port, a receiver, a transmitter, and storage devices (e.g., a tape drive, a floppy drive, a hard disk drive, a compact disk drive, and the like)).

It will be appreciated that the functions depicted and described herein may be implemented in software and/or hardware, e.g., using a general purpose computer, one or more application specific integrated circuits (ASIC), and/or any other hardware equivalents. In one embodiment, the cooperating process 705 can be loaded into memory 704 and executed by processor 702 to implement the functions as discussed herein. Thus, cooperating process 705 (including associated data structures) can be stored on a computer readable storage medium, e.g., RAM memory, magnetic or optical drive or diskette, and the like.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal-bearing medium, and/or stored within a memory within a computing device operating according to the instructions.

In the various embodiments described above, each route update received by, illustratively, a BGP device is fully processed to (1) enforce policy based rules by applying import and export policies; and (2) characterize the update according to its attributes to generate a unique cache object associating the characterizing objects and the policy information. For subsequent route updates received by the BGP, the attributes characterizing the received update are compared to the attributes of the cache objects and, if the same, the policy information associated with the cache object is used instead of results from any policy rules processing that would be obtained by fully processing the configured RegEx.

This concept of caching RegEx processing results allows for rapid evaluation of policy rules on incoming BGP updates while avoiding the normal, repetitive and CPU intensive RegEx evaluation operation. In this manner, the embodiments provide a mechanism that reduces the total processing load associated with BGP updates such that a relatively fast convergence (updating) of local routing tables may occur.

In various embodiments, the size and or duration of a particular epoch is adapted in response to empirical data gathered while processing the various regular expressions include within policy updates.

Within the context of the various embodiments, CPU intensive regular expression matching operations associated with incoming BGP policy updates are reduced by caching prior results and using those results where appropriate.

The various methods described above utilize epoch entries to manage policy defined by regular expression identifiers. Advantageously, this provides excellent ID management as various RegEx ID's are allocated and freed during and across policy commit operations. Moreover, the use of sequential ID allocation in some embodiments, as well as a straightforward cache implementation is enabled by the various methods described herein. It is also noted that stale cache entries are invalidated upon access without the use of a specific messaging mechanism.

Although various embodiments which incorporate the teachings of the present invention have been shown and described in detail herein, those skilled in the art can readily devise many other varied embodiments that still incorporate these teachings.

What is claimed is:

1. A method for use in a network element including a memory, the network element processing packets according to actions defined by a plurality of rules provided as regular expressions, the method comprising:
for each packet to be processed by the network element:
in response to the packet having attributes matching attributes of a previously processed packet within a current epoch, processing the packet according to the actions used to process the previously processed packet; and
in response to the packet having attributes not matching attributes of a previously processed packet within the current epoch, comparing the packet to each of the plurality of regular expressions to determine which rules match the packet, processing the packet according to the actions defined by the rules matching the packets, and storing in a cache an attribute object associated with the packet and with the rules matching the packet.

2. The method of claim 1, wherein said regular expressions are stored in a regular expression map, said method further comprising:
for each policy update to be processed by the network element, assigning a unique available identifier to each new rule included within the policy update, and storing in said regular expression map each new rule and its assigned identifier.

3. The method of claim 1, wherein determining whether attributes of said packet match attributes of a previously processed packet comprises comparing an attribute object associated with said packet to attribute objects stored within said cache.

4. The method of claim 3, wherein a circular redundancy check (CRC) is used to determine whether attributes of said packet match attributes of a previously processed packet.

5. The method of claim 3, wherein a hash table is used to determine whether attributes of said packet match attributes of a previously processed packet.

6. The method of claim 5, wherein said storing in a cache an attribute object associated with the packet comprises hashing said attribute object into a hash table.

7. The method of claim 2, wherein each epoch is associated with a plurality of RegEx IDs, and a next epoch is initiated in response to the assignment of each of said plurality of RegEx IDs to attribute objects.

8. The method of claim 7, wherein initiating a next epoch includes clearing the cache.

9. The method of claim 7, wherein each epoch uses the same plurality of RegEx IDs.

10. The method of claim 1, wherein:
in response to a determination that the received packet exhibits attributes of a predetermined type:
processing the received packet according to one or more regular expressions to extract therefrom any packet processing instructions.

11. The method of claim 1, wherein for each policy update to be processed by the network element, assigning a unique available identifier to each modified rule included within the policy update, and storing in said regular expression map each modified rule and its assigned identifier.

12. The method of claim 11, wherein said storing in said regular expression map further comprises storing a current epoch ID.

13. The method of claim 12, wherein said determination that a received packet does not match a previously received packet during a current epoch includes comparing the epoch ID of a cached RegEx object to a current epoch ID.

14. The method of claim 1, wherein said network element comprises a routing device using the border gateway protocol (BGP) and regular expressions are stored in either of a Communities RegEx map and an AS-Paths RegEx map.

15. The method of claim 1, wherein attributes associated with processed network packets are stored in one of a RIB-IN attributes map and a RIB-OUT attributes map.

16. The method of claim 1, wherein a RIB-IN RegEx cache stores, for each input network packet processed in an epoch, attribute objects according to RIB-IN attributes map and RegEx objects according to one of a Communities RegEx map and an AS-Paths RegEx map.

17. The method of claim 1, wherein a RIB-OUT RegEx cache stores, for each output network packet processed in an epoch, attribute objects according to RIB-OUT attributes map and RegEx objects according to one of a Communities RegEx map and an AS-Paths RegEx map.

18. A computer readable medium including software instructions which, when executed by a processer, perform a method for use in a network element including a memory, the network element processing packets according to actions defined by a plurality of rules provided as regular expressions, the method comprising:
for each packet to be processed by the network element:
in response to the packet having attributes matching attributes of a previously processed packet within a current epoch, processing the packet according to the actions used to process the previously processed packet; and
in response to the packet having attributes not matching attributes of a previously processed packet within the current epoch, comparing the packet to each of the plurality of regular expressions to determine which rules match the packet, processing the packet according to the actions defined by the rules matching the packets, and storing in a cache an attribute object associated with the packet and with the rules matching the packet.

19. A computer program product, wherein a computer is operative to process software instructions which adapt the operation of the computer such that computer performs a method, comprising:
for each packet to be processed by the network element:
in response to the packet having attributes matching attributes of a previously processed packet within a current epoch, processing the packet according to the actions used to process the previously processed packet; and
in response to the packet having attributes not matching attributes of a previously processed packet within the current epoch, comparing the packet to each of the plurality of regular expressions to determine which rules match the packet, processing the packet according to the actions defined by the rules matching the packets, and storing in a cache an attribute object associated with the packet and with the rules matching the packet.

20. An apparatus for processing regular expressions at a network element, comprising:
a regular expression processor, for processing regular expressions received via policy updates and storing said regular expressions in one of a Communities RegEx map and an AS-Paths RegEx map;
a BGP engine, for processing network packets according to stored regular expressions and storing network packet attributes and processing results in a cache, wherein the BGP engine processes a subsequent network packet within an epoch in the same manner as a matching network packet processed within the epoch.
